(19) United States
(12) Patent Application Publication
(10) Pub. No.: US 2008/0068851 A1
(43) Pub. Date: Mar. 20, 2008

(54) Exterior rear-view mirror for vehicles, in particular motor vehicles

(76) Inventor: Bernd Waldmann, Nurtingen (DE)

Correspondence Address: REISING, ETHINGTON, BARNES, KISSELLE, P.C., P O BOX 4390, TROY, MI, 48099-4390, US

(21) Appl. No.: 11/578,738

(22) PCT Filed: Mar. 31, 2005
(86) PCT No.: PCT/EP05/03360

§ 371 Date: Jul. 23, 2007

(30) Foreign Application Priority Data
Apr. 17, 2004 (DE) 10 2004 018 695.2

(51) Int. Cl. B60R 1/12

(52) U.S. Cl. 362/494

(57) ABSTRACT

The invention relates exterior rearview mirrors, wherein lighting units (8) in the form of a repeating direction indicator lamp are housed in the mirror head (1). In order for the diffuser panel (14) to be substantially invisible when not illuminated, the diffuser panel is configured on its exterior in such a manner that it is invisible from the exterior when not illuminated, while the light beams emitted by the illumination means (25) have sufficient luminous intensity after passage through the diffuser panel (14). The exterior rearview mirror is especially suitable for motor vehicles.

The invention relates to an exterior rear-view mirror for vehicles, in particular for motor vehicles, according to the preamble of claim 1.

Known in the art are exterior rear-view mirrors in whose mirror head a repeating direction indicator lamp is housed as a lighting unit. This provides the feature that, by switching on the repeating direction indicator lamp, motorists and cyclists who are next to the vehicle on the side can reliably recognize that the vehicle is turning.

The objective of the invention is to form a generic exterior rear-view mirror in such a manner that, in the unlighted state, the light diffuser panel of the lighting unit is essentially unrecognizable.

In a generic exterior rear-view mirror this objective is realized according to the invention with the characterizing features of claim 1.

In the exterior rear-view mirror according to the invention, the light diffuser panel is not recognizable if the lighting means are not switched on. Nonetheless, it is ensured that the light emitted by the lighting means has the legally prescribed intensity after passing through the light diffuser panel.

The light diffuser panel is advantageously covered by a coating on its outer side. However, it only has a thickness such that the light emitted by the lighting means

The invention relates to an exterior rear-view mirror for vehicles, in particular for motor vehicles, according to the preamble of claim 1.

Known in the art are exterior rear-view mirrors in whose mirror head a repeating direction indicator lamp is housed as a lighting unit. This provides the feature that, by switching on the repeating direction indicator lamp, motorists and cyclists who are next to the vehicle on the side can reliably recognize that the vehicle is turning.

The objective of the invention is to form a generic exterior rear-view mirror in such a manner that, in the unlighted state, the light diffuser panel of the lighting unit is essentially unrecognizable.

In a generic exterior rear-view mirror this objective is realized according to the invention with the characterizing features of claim 1.

In the exterior rear-view mirror according to the invention, the light diffuser panel is not recognizable if the lighting means are not switched on. Nonetheless, it is ensured that the light emitted by the lighting means has the legally prescribed intensity after passing through the light diffuser panel.

The light diffuser panel is advantageously covered by a coating on its outer side. However, it only has a thickness such that the light emitted by the lighting means has the legally prescribed intensity after passing through the coating.

Additional features of the invention follow from the additional claims, the description, and the drawings.

The invention will be further explained in more detail with the aid of several forms of embodiment represented in the drawings. Shown are:

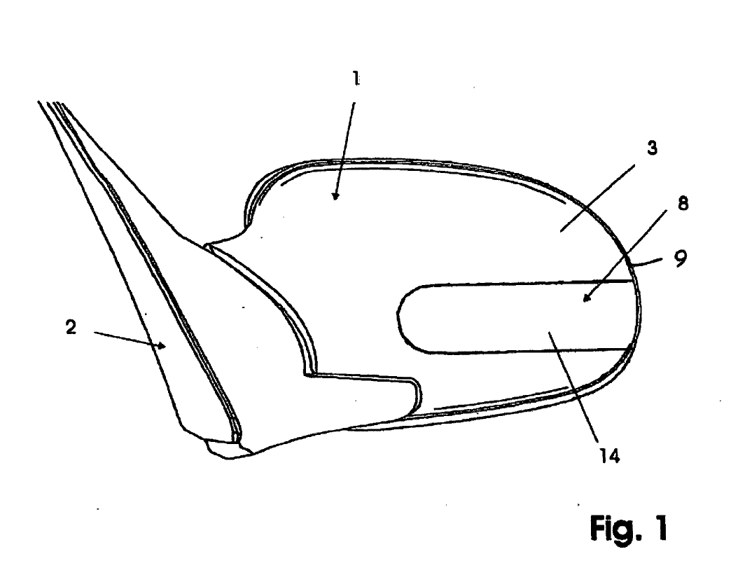

FIG. 1 in a simplified and perspective representation, an exterior rear-view mirror according to the invention and with a repeating direction indicator lamp,

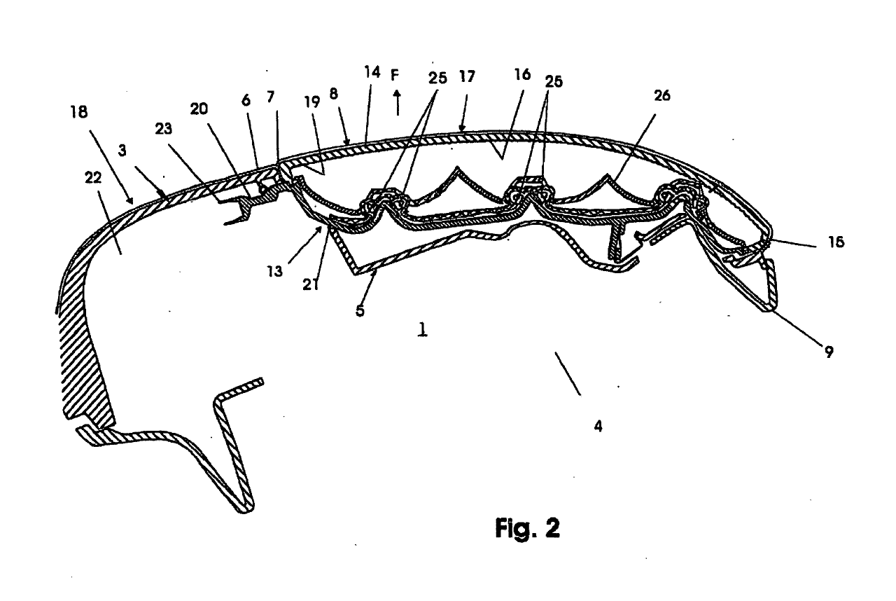

FIG. 2 in an enlarged representation, a longitudinal section through the mirror head of the mirror according to FIG. 1,

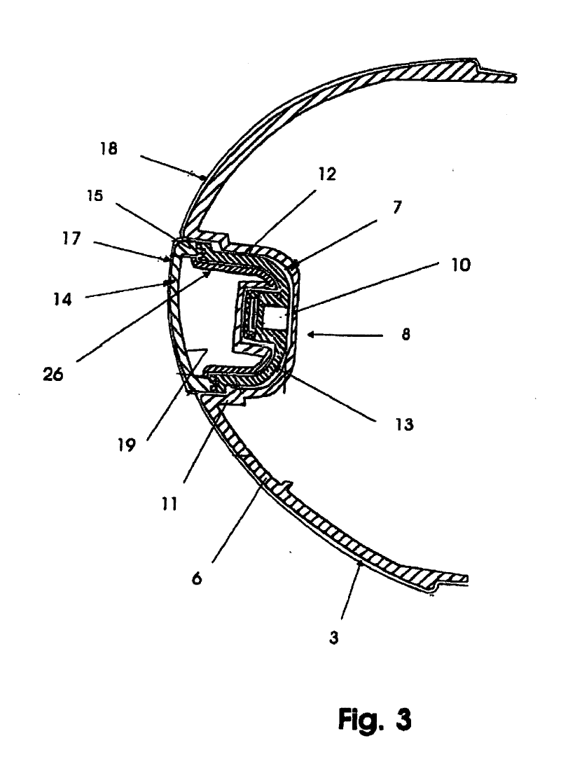

FIG. 3 a cross section through the mirror head according to FIG. 1

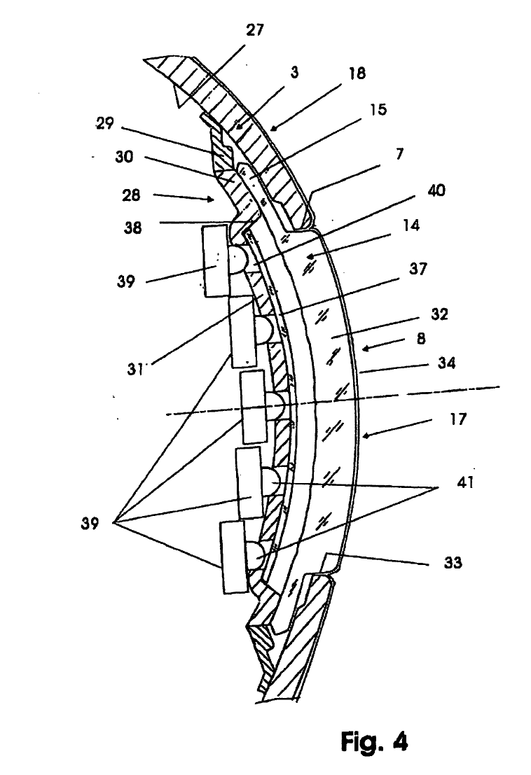

FIG. 4 a part of the mirror head of an additional form of embodiment of an exterior rear-view mirror according to the invention in a representation corresponding to FIG. 2,

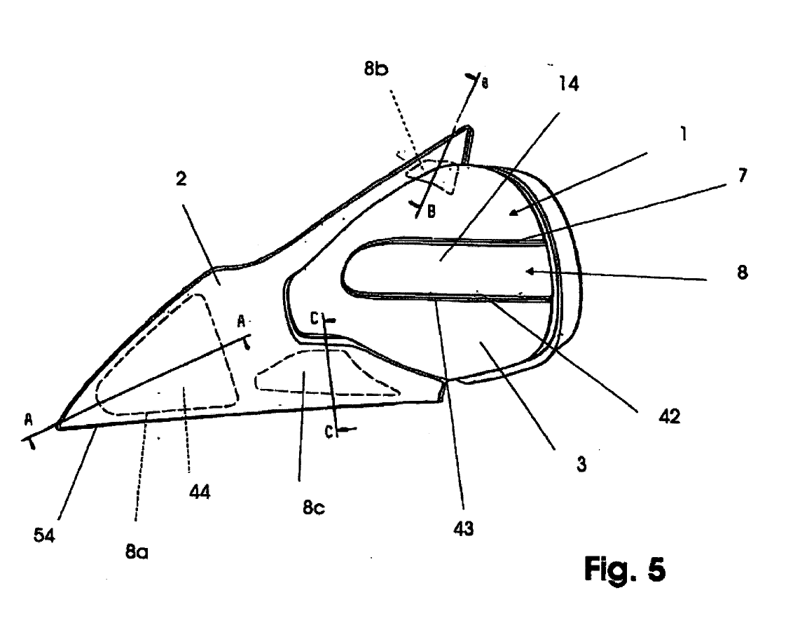

FIG. 5 in a view from the rear, an additional form of embodiment of an exterior rear-view mirror according to the invention and with a lighting unit,

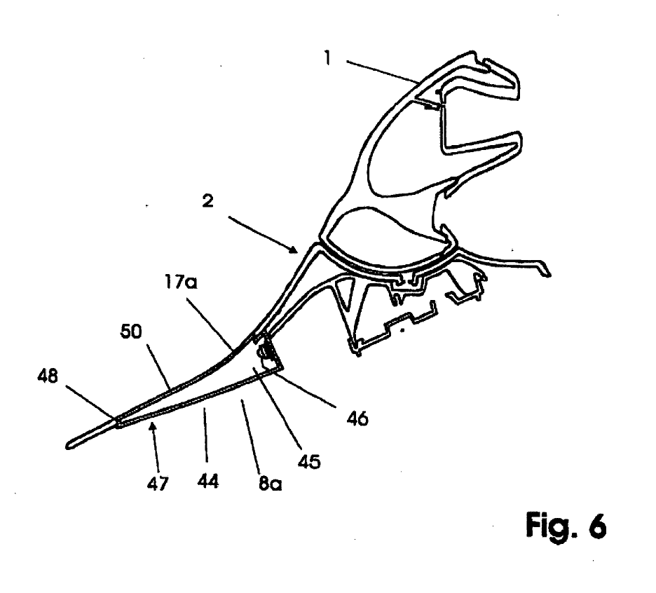

FIG. 6 a section along the line A-A in FIG. 5,

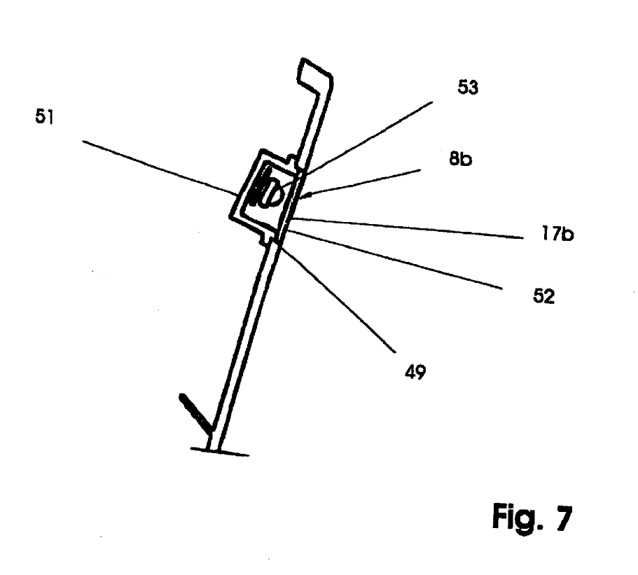

FIG. 7 a section along the line B-B in FIG. 5,

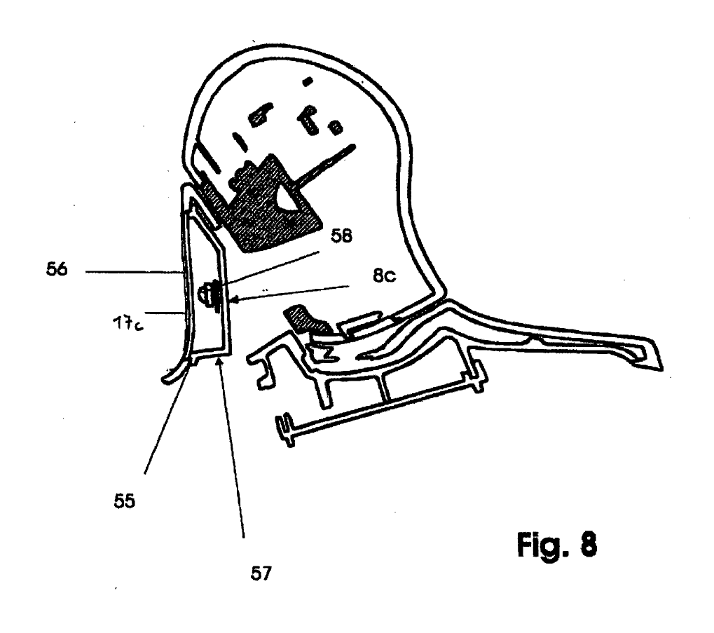

FIG. 8 a section along the line C-C in FIG. 5.

The exterior rear-view mirror according to the FIGS. 1 to 3 is provided for vehicles, in particular motor vehicles. It has a mirror head 1, which, in a known manner, is connected, in such a manner that it can fold out, to a mirror foot 2. The mirror head 1 can be folded out towards, in the sense of the direction of travel, the front and the back. The mirror head 1 has a housing 3 which advantageously consists of plastic and has on its back side, which faces, in the sense of the direction of travel, to the rear, an opening 4 (FIG. 2) for the (not represented) mirror glass holder with the mirror glass. This mirror glass holder is, in a known manner, mounted, in such a manner that it can be displaced, on a holder 5 which is housed inside the housing 3. Advantageously, the mirror glass holder can be displaced under the control of a motor.

Pointing, in the sense of the direction of travel F, forwards, the front side 6 of the housing 3 is provided with a receptacle 7 (FIG. 2) formed in the shape of a recess, into which a lighting unit 8 serving as a repeating direction indicator lamp is inserted.

As FIGS. 1 and 2 show, the lighting unit 8 extends over more than half of the width of the mirror head 1 up to an outer edge 9 of the housing 3, specifically the outer edge opposite the motor vehicle. The receptacle 7, which is open towards the front side 6 of the mirror head 1, has, at least over a part of its length, a base 10 (FIG. 3), which, via side walls 11, 12, turns into the front wall 6 of the housing 3. Advantageously, the base 10 and the side walls 11, 12 of the receptacle 7 are formed as one piece with the housing 3.

The lighting unit 8 has a light housing 13, which is approximately adapted in its contour to the cross-sectional form of the receptacle 7. The light housing 13 is closed on its side aligning with the front wall 6 of the housing 3 by a light diffuser panel 14. The light diffuser panel's edge 15 is angled inwards in the direction towards the receptacle 7. The light diffuser panel 14 consists of material permeable to light and can be provided on its inner side with a lens structure 16 (FIG. 2).

The light diffuser panel 14 is fastened by its angled, encircling edge 15 to the edge of the light housing 13. The light diffuser panel 14 and the light housing 13 advantageously consist of plastic. A projection 20 (FIG. 2) of the light housing 13 extends, through an opening 21 in the side wall of the receptacle 7 and in the holder 5, into the inner space 22 of mirror head 1, i.e., the space enclosed by the housing 3. The projection 20 is provided on an edge of the elongated light housing 13, specifically the edge near the mirror foot 2, and is preferably formed as one piece with it. On the projection 20 a plug 23 is provided, via which the lighting unit 8 is provided with the necessary electrical power.

Between the light housing 13 and the light diffuser panel 14 there is a reflector 26, which reflects, towards the light diffuser panel 14, light emitted by the lighting means 25.

The light diffuser panel 14 is provided in the embodiment example with a coating 17 which is of the same color as the mirror housing 3. It can also be provided with a coating 18 or can consist of a colored plastic. The coating 17 is formed by painting.

The thickness of the coating 7 is chosen so that the light diffuser panel 14 is not recognizable if the lighting means 25 are not switched on. Therefore, when the lighting means 25 is not switched on, the lighting unit 8 inserted in the mirror head 1 is not recognizable. The gap between the light diffuser panel 14 and the adjacent area of the mirror housing 3 is so narrow that it is practically invisible. Advantageously, the coating 18 of the mirror housing 3 extends up to the side walls 11, 12 of the receptacle 7 so that the gap is not recognizable from outside due to the two coatings having the same color.

The coating 17 is only thick enough that, when the lighting unit 8 is switched on, the light emitted by the lighting means 25 exits, through the light diffuser panel 14, at the required intensity.

The color of the mirror head 1 is advantageously adapted to the color of the vehicle on which the exterior rear-view mirror is mounted. It is particularly advantageous if the mirror foot 2 is also of the same color as the mirror head 1. The mirror foot 2 can be provided with coating, or be made of a plastic, whose color in either case corresponds to that of the housing 3 of the mirror head 1.

The color of the mirror head 1, and in given cases the mirror foot 2, can be black or white.

Instead of a paint layer 17, a colored foil or a covering can be used which is formed by a metal vapor deposition, such as, for example, chromium vapor deposition, or nickel vapor deposition, or the like.

Advantageously, LEDs are provided as lighting means 25. The light emitted by them is in part transmitted directly to the light diffuser panel 14 and in part reflected by the reflector 26 to the light diffuser panel.

The light housing 8 can have the most varied forms in contour and a varying design from the standpoint of construction. In the form of embodiment according to FIG. 4 the light diffuser panel 14 is formed as a light guide, with which an optimal illumination of the light diffuser panel is ensured. As FIG. 4 shows, the light diffuser panel 14 has the encircling edge 15 which is thinner than the part of the light diffuser panel 14 disposed in the opening of the receptacle 7. The light diffuser panel 14 lies with its edge 15 on the inner side 27 of the housing 3 and along the edge of the installation opening of the receptacle 7. The light diffuser panel 14 is pressed by a cover part 28 against the inner side 27 of the housing 3. The cover part 28 is provided along its edge with an encircling seal 29, which preferably consists of rubber and lies on the inner side 27 of the housing 3. The seal 29 is advantageously injected onto the edge of the cover part 28.

The cover part 28 has an encircling edge 30 which lies flat on the edge 15 of the light diffuser panel 14. The remaining part 31 of the cover part 28 is set back with respect to the edge 30 and is spaced from the light diffuser panel 14. The area 31 of the cover part 28 is approximately adapted to the contour of a part of the light diffuser panel 14, specifically the part located in the receptacle opening. The cover part 28 is fastened to the housing 3. Said cover part causes the edge 15 of the light diffuser panel 14 to be pressed firmly against the inner side 27 of the housing 3. Along with this, the edge-side seal 29 is also deformed elastically so that it ensures faultless sealing. The edge 15 of light diffuser panel 14 is adapted to the inner side 27 of the housing 3 so that the edge 15 lies flat on the inner side of the housing. The light diffuser panel 14 is thereby faultlessly secured in position. A part 32 of the light diffuser panel 14, specifically the part located in the receptacle opening 4, is formed so that it lies with its edge 33 on the edge of the opening of the receptacle 7. The outer side 34 of the light diffuser panel 14 is formed so that it forms a continuous extension of the housing's outer side 35 in the area of the receptacle 7.

Behind the cover part 28, LEDs 39 are disposed over and alongside one another at an end area of the diffuser panel 14, specifically the end area opposite the vehicle. The LEDs 39 have a long service lifetime and short rise times. The LEDs 39 are fastened, in a suitable manner, in the mirror head 1 and connected to the electrical system of the motor vehicle. So that the light emitted by the LEDs 39 can exit through the light diffuser panel 14, the cover part 28 is provided with through-openings 40 for the beams emanating from the LEDs 39. The light-emitting elements 41 of the LEDs 39 project into the cylindrically formed through-openings 40. The through-openings 40 serve as a sunshield in case of obliquely incident sunlight. Since the light-emitting elements 41 of the LEDs 39 project only partially into the through-openings 40, it is ensured that the illuminated light diffuser panel 14 can be recognized reliably in obliquely incident sunlight. The LEDs 39 can be colored.

The light emitted by the LEDs 39 arrives, through the through-openings 40 and the foil/plastic panel 37, at the light diffuser panel 14. Since it is formed as a light guide, the incident light is distributed over the entire surface of the light diffuser panel. The illuminated light diffuser panel 14 is well recognizable, even in bright sunlight. Since the light diffuser panel 14 extends from approximately the mirror foot 2 up to near an end of the mirror housing 3, specifically the end opposite the motor vehicle, the illuminated light diffuser panel 14 can be faultlessly and reliably recognized in traffic. Also, several light diffuser panels 14 can be provided. The LEDs 39 with the light diffuser panel 14 serve as repeating direction indicator lamps.

Also in the case of this form of embodiment the light diffuser panel 14 is provided with a coating 17 which is formed in the same manner as in the previous embodiment example. The mirror foot 2 can be formed in the same manner as in the embodiment example according to FIGS. 1 to 3.

In the described forms of embodiment the lighting unit 8 can also be housed in the mirror foot 2, or partly in the mirror foot. The configuration of the lighting unit in the mirror foot 2 advantageously corresponds to the configuration of the lighting unit in the mirror head 1.

In the mirror head 1, as well as partially also in the mirror foot 2, it is also possible to house in addition, and in any combination, a heating element for the mirror glass, an antenna, a GPS module, at least one peripheral illumination element, at least one sensor of an automatic dimming device, a camera, at least one loud speaker, a temperature sensor, and the like.

FIGS. 5 and 8 show an additional form of embodiment of an exterior rear-view mirror of a motor vehicle, said exterior rear-view mirror, as in the previously described forms of embodiment, comprising the mirror foot 2 with the mirror head 1 disposed thereon in such a manner that it can be folded out. In the receptacle 7 of the mirror head 2 the lighting unit 8 is also inserted with its light diffuser panel 14 in a position such that its outer side terminates flush with the outer side of the housing 3. So that the light diffuser panel 14, and thus the lighting unit 8, is not recognizable from outside, the coating is applied on the outer side of the light diffuser panel 14, said coating advantageously being formed by a layer of paint. Corresponding to the previous forms of embodiment, this layer of paint is only thick enough that the light diffuser panel 14 is covered but the light emitted by the lighting means of the light diffuser panel 14 can exit at a sufficient intensity. This coating on the light diffuser panel 14 is advantageously of the same color as the coating on the rest of the housing 3. The coating can be applied so that the gap 42 between the edge 43 of the receptacle 7 and the light diffuser panel 14 is completely covered. In this case, the housing 3 has a continuously smooth layer of paint so that the mirror head 1 has the same appearance as a mirror head without an opening and without lighting. It is, however, also possible, for structural reasons, not to cover with the coating the gap 42 between the edge of the opening and the edge of the light diffuser panel 14. The light diffuser panel 14 is in any case covered by this coating to the extent that it is not recognizable from outside as long as the lighting unit 8 is not switched on. The gap 42 is in any case sufficiently sealed that humidity and/or dirt cannot reach the interior of the mirror head 1.

The exterior rear-view mirror can also comprise at least one lighting means in the mirror foot 2. This lighting means can be provided in addition to the lighting unit 8 in the mirror head 1. It is, however, also possible that the mirror head comprises no lighting in this case.

In FIG. 5 three exemplary possibilities for installing lighting units in the mirror foot 2 are indicated with dotted lines. The area 44 is provided in the corner of the mirror foot 2. In the area 44 the mirror foot 2 is provided with a receiving space 45 in which the lighting unit 8a is housed with at least one lighting means 46, preferably an LED. The light emitted by the lighting means 46 exits through a diffuser panel 50. It is a component of a housing 47 in which the lighting means 46 are located. The diffuser panel 50 fills the opening which is provided in the mirror foot 2. The outer side of the diffuser panel 50 forms a continuous extension of the outer side of the mirror foot 2. The diffuser panel 50 consists of a material permeable to light. The coating 17a is applied on the outer side of the diffuser panel 50, said coating advantageously being a layer of paint. The coating 17a is once again applied so as to be thick enough that the light diffuser panel 50 is not recognizable from outside but thin enough that the light emitted by the lighting means 46 can exit, through the light diffuser panel 50 and the coating 17a, at a sufficient intensity. The coating 17a, advantageously, is of the same color as the coating on the outer side of the mirror foot 2. As in the previous forms of embodiment, the housing 47 is thus not visible from outside when the lighting means 46 are not switched on.

It is also possible that the mirror foot 2 comprises no installation opening 48 but rather that the housing 47 is fastened to the light diffuser panel 50 on the inner side of the mirror foot 2. Then the wall of the mirror foot 2 in the area of the light diffuser panel 50 is made of transparent material and provided with a coating 17a.

It is also possible in this case to make the entire mirror foot 2 of material permeable to light and provide it with a coating 17a. This coating is so thin in the area of the light diffuser panel 50 that the light beams can exit.

FIG. 7 shows an additional possibility for installing the lighting unit 8b. As FIG. 5 shows, the lighting unit 8b is located in the upper corner area of the mirror foot 2. In this area the mirror foot 2 has an installation opening 49 (FIG. 7), into which the lighting unit 8b is inserted in such a manner that the outer side of the light diffuser panel 52 lies flush with the outer side of the mirror foot 2. The light diffuser panel 52 is part of the housing 51 in which at least one lighting means 53, preferably an LED, is housed. The light diffuser panel 52 consists of material permeable to light and is provided with a coating 17b, which, corresponding to the previous forms of embodiment, is thick enough that the light diffuser panel 52 is not recognizable but is thin enough that light beams emitted by the lighting means 53 can exit, through the light diffuser panel and the coating 17b, at a required intensity. The coating 17b is advantageously of the same color as the coating on the outer side of the mirror foot 2.

The wall of the mirror foot 2 can also be formed to be continuous in this area, while the lighting unit 8b is fastened to the back side of this wall. The wall of the mirror foot 2 in this area is made of material permeable to light and is provided in this area with the coating 17b. It is also possible to make the entire mirror foot 2 of material permeable to light and to provide it with a coating. In the area of the lighting unit 8b it is formed to be thin enough that the light emitted by the lighting means 53 can exit at the required intensity.

Finally, the mirror foot 2 can have the lighting unit 8c in the area of an edge 54 of the mirror foot 2, specifically the edge facing the ground. The lighting unit 8c lies in this case at least partially below the mirror head 1. The lighting unit 8c has in turn the housing 55, whose light diffuser panel 56 is inserted into an installation opening 57 of the mirror foot 2. The outer side of the light diffuser panel 56 forms a continuous extension of the mirror foot 2. The light diffuser panel 56 consisting of material permeable to light is provided with a coating 17c, which, corresponding to the previous forms of embodiment, is preferably formed by a layer of paint. The coating 17c is in turn thick enough that the light diffuser panel 56 is not recognizable from outside but is thin enough that the light emitted by the lighting means 58 in the housing 55 can exit at the required intensity. The coating 17c on the light diffuser panel 56 is advantageously of the same color as the coating on the mirror foot 2. Finally, it is possible to form the wall of the mirror foot 2 in this area to be continuous and to fasten the housing 55 to the inner side of the mirror foot 2. The wall of the mirror foot 2 in the area of the housing 55 is made of material permeable to light. The coating of the mirror foot 2 in this area is formed to be thin enough that the light can exit. It is furthermore possible to make the entire mirror foot 2 of material permeable to light and provide it with a coating which is so thin in the area of the light diffuser panel 56 or the light housing 55 that the light can exit.

The mirror foot 2 customarily comprises only one of the lighting units 8a to 8c. It is, however, possible to provide, in the manner described, two or even more lighting units in the mirror foot 2. Along with this, the mirror head 1 can also comprise the lighting unit 8.

In the forms of embodiment described, the diffuser panel 14, 50, 52, or 56 of the lighting units is each provided with a coating. However, it is also possible that the diffuser panel is formed, at least on its outer side, so that it is not recognizable from outside if the lighting means are not switched on. Such a formation is advantageously achieved by the diffuser panel consisting of an appropriately colored plastic. One provides coloring such that the light emitted by the lighting means in the lighting unit can exit at sufficient intensity. The color of the plastic can be such that the diffuser panel has the same color as the mirror head 1 and/or as the mirror foot 2.

The mirror head 1, the mirror foot 2, and the diffuser panel of the lighting unit can obviously also be of the different colors.

1. An exterior rear-view mirror for vehicles, in particular motor vehicles, with a housing, which comprises at least one receptacle for at least one lighting unit, in particular a repeating direction indicator lamp, with a light diffuser panel behind which at least one lighting means is disposed, characterized by the fact that the light diffuser panel (14, 50, 52, 56) is formed at least on its outer side so that in the unlighted state it cannot be seen from outside although the light beams emitted by the lighting means (25, 39, 46, 53, 58) have sufficient intensity after they exit through the light diffuser panel.

2. Mirror according to claim 1 characterized by the fact that the light diffuser panel (14, 50, 52, 56) is provided on its outer side with a coating (17, 17a, 17b, 17c) which is thick enough that the light diffuser panel (14, 50, 52, 56) is covered but the light beams emitted by the lighting means (25, 39, 46, 53, 58) have sufficient intensity after they exit through the coating (17, 17a, 17b, 17c).

3. Mirror according to claim 2, characterized by the fact that the coating (17, 17a, 17b, 17c) is of the same color as the housing (3).

4. Mirror according to claim 3, characterized by the fact that the coating (17, 17a, 17b, 17c) is formed by a layer of paint.

5. Mirror according to claim 3 , characterized by the fact that the coating (17, 17a, 17b, 17c) is a foil.

6. Mirror according to claim 3, characterized by the fact that the coating (17, 17a, 17b, 17c) is formed by vapor deposition, preferably by metal vapor deposition, such as chromium vapor deposition and/or nickel vapor deposition.

7. Mirror according to claim 1, characterized by the fact that the light diffuser panel (14, 50, 52, 56) consists of colored plastic.

8. Mirror according to claim 7, characterized by the fact that the housing (3) is provided with a coating (18).

9. Mirror according to claim 8, characterized by the fact that the coating (17, 17a, 17b, 17c) of the light diffuser panel (14, 50, 52, 56) and the coating (18) of the housing (3) are of the same color.

10. Mirror according to claim 7, characterized by the fact that the housing (3) consists of a colored plastic.

11. Mirror according to claim 10, characterized by the fact that the colored plastic is of the same color as the coating (17, 17a, 17b, 17c) of the light diffuser panel (14, 50, 52, 56).

12. Mirror according to claim 11, characterized by the fact that the light housing (13, 51) is part of the mirror head (1).

13. Mirror according to claim 12, characterized by the fact that light housing (47, 51, 55) is part of the mirror foot (2).

14. Mirror according to claim 13, characterized by the fact that the coating (17, 17a, 17b, 17c) of the light diffuser panel (14, 50, 52) is of the same color as the vehicle.
